(19) United States
(12) Patent Application Publication
(10) Pub. No.: US 2011/0067633 A1
(43) Pub. Date: Mar. 24, 2011

(54) VIBRATION MECHANISM FOR VERTICAL EGG ALIGNMENT PRIOR TO IN-OVO INJECTION

(76) Inventors: Rafael S. Correa, Salisbury, MD (US); William D. Samson, Salisbury, MD (US); Mark A. Dekich, Salisbury, MD (US)

(21) Appl. No.: 12/735,521

(22) PCT Filed: Jan. 23, 2009
(86) PCT No.: PCT/US09/00470

§ 371 Date: Nov. 22, 2010

Related U.S. Application Data
(60) Provisional application No. 61/006,609, filed on Jan. 23, 2008.

(51) Int. Cl. A01K 45/00; B65G 27/00

(52) U.S. Cl. 119/6.8; 198/752.1

(57) ABSTRACT

An in-ovo egg injection machine generates and transmits vibration to an incubating egg tray to align the egg axes prior to injection. The mechanism can be used independently of the in-ovo egg injection machine and is suitable for use with an egg candling machine. With the eggs positioned on the incubating tray and held by egg tray posts with their large ends facing upward for the purposes of incubation, vibration is applied to the tray. The vibration allows the eggs to ‘float’ in their restricted locations in the egg tray. Since the eggs are naturally bottom-heavy, the heaviest portion of each egg moves down as the tray is vibrated. The eggs therefore self-align their axes into an orientation corresponding with the established vertical axes of the injectors, respectively, with no contact with the eggs being required.

### BACKGROUND OF THE INVENTION

1. Field of the Invention

The present invention is related to the field of in-ovo egg vaccination and, more particularly, to a device for orienting the axis of eggs to be injected so as to be in alignment with the vertical axis of injectors in an in-ovo egg injection machine during injection.

2. Description of the Related Art

Egg incubation trays include a plurality of egg tray posts that define individual locations for receiving a single egg and keeping it in a spaced relationship with respect to the other eggs in the tray. These egg tray posts allow for variations in egg size, shape and orientation as these variations do not impact the incubation process. Because these egg incubation trays hold and present the eggs in a set pattern, they are also used in the in-ovo vaccination process which typically uses a machine having egg injectors arranged in the same pattern as that provided for the eggs by the trays.

Difficulties arise because the egg tray posts, in accommodating the egg size, shape and orientation variations, do not ensure that the axes of the eggs are respectively aligned with the typical vertical axes of the injectors. When correctly aligned, the egg, which has an air cell located in the large end thereof, presents this air cell in line with the vertical axis of the injector. The injection needle is then placed in the air cell and deposited in the amniotic fluid, with no injury to the embryo positioned below the air cell. When misaligned, however, the injection needle can strike the embryo in the body, resulting in an intramuscular vaccine delivery. The embryo has very limited muscular development at 18 to 19 days of incubation and because the vaccine delivery needle must be of sufficient size in diameter to have the strength to repeatedly perforate the egg shell, this body injection can cause significant trauma. When the chick hatches on the 21^{st} day, the resulting trauma such as an open wound can easily be contaminated through contact with unclean used bedding in the field.

A solution to the problem of variance in egg axis alignment from the perspective of ensuring the needle successfully penetrates the egg shell is presented in U.S. Pat. No. 4,903,635 (“the '635 patent”), which uses translational movement to orient the injector so that the needle will not glance off the egg during injection. This approach only compounds the problem of embryo intramuscular and body injection of vaccine, however, due to the fact that the '635 patent fixes or secures the upper portion of the injector furthest from the egg resulting in the egg axis and the injector axis meeting at intersecting angles.

Accordingly, a need exists for a system and method of in-ovo injection that ensures that the axis of the egg is in alignment with the vertical axis of the injector prior to injection.

### SUMMARY OF THE INVENTION

In view of the foregoing, one object of the present invention is to prevent chick embryo trauma resulting from body or intramuscular contact with the needle during in-ovo injection.

Another object of the present invention is to provide an aligning mechanism for use with an in-ovo injection machine that brings the center axis of each of a plurality of eggs into alignment with the vertical center axis of a plurality of injectors, respectively, while the eggs are still resting on the incubator tray.

A further object of the present invention is to provide an aligning mechanism in accordance with the previous object that allows the eggs to automatically orient themselves vertically with no requirement for direct egg contact and, therefore, without any risk of cross-contamination.

Yet another object of the present invention is to provide an aligning mechanism in accordance with the previous objects that can be used in line independently of the in-ovo injection machine or incorporated in the in-ovo injection machine just prior to in-ovo injection.

A still further object of the present invention is to provide an aligning mechanism in accordance with the previous objects that improves the likelihood that a vaccine dosage delivered by the in-ovo injection machine will be deposited in the amniotic fluid as intended.

Still another object of the present invention is to provide an aligning mechanism in accordance with the previous objects that reduces the instances of clogged needles caused by muscle and cartilage plugs following unintended intramuscular and body injection.

An additional object of the present invention is to provide an in-ovo injection process that improves hatchability by reducing the number of head traumas caused by the injection needles and reduces first week mortality among newly hatched chicks.

Yet a further object of the present invention is to provide a method of injecting eggs in an egg tray using an in-ovo injection machine that includes applying vibration to the egg tray prior to injection in order to allow the eggs to self-align in response to gravity and the eggs' own weight differential between the two ends thereof.

Still yet another object of the present invention is to provide an egg aligning mechanism that is not complex in structure and which can be integrated with existing in-ovo injection machines to efficiently and reliably increase the rate of successful in-ovo injection into the amniotic fluid.

In accordance with these and other objects, the present invention is directed to a vibration mechanism for generating and transmitting vibration to an incubating egg tray, either independently of the in-ovo injection machine or incorporated within such a machine at a point prior to injection. The eggs, previously positioned on the incubating tray with their air cells facing up for the purposes of incubation, are bottom-heavy due to the positioning of the yolk fluids in the bottom portion of the egg. It has now been surprisingly found that when vibration is applied to the tray using a vibration mechanism, gravity works in conjunction with the egg shape and the egg weight differential between the air cell and the yolk fluid ends of the egg to reorientate the heaviest portion of the egg downwardly. This reorientation of the heaviest portion is facilitated by the fact that the vibration reduces the friction caused by the egg tray posts that locate and hold each egg such that the egg is made to “float” in its restricted location by the vibration. In “floating”, the egg is able to self-align its axis into a vertical orientation corresponding with the vertical axis of its corresponding injector. The vibration can be transmitted to the egg tray from any angle, whether from the top, bottom or side of the tray, to create the desired effect. Vibration intensity is preferably adjustable to correspond with the egg tray and its total mass and weight. The vibration mechanism may be of any known design, including for example, mechanical, pneumatic, hydraulic, electronic and ultrasonic.

These advantages and capabilities, together with other objects and advantages which will become subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a front perspective view of a prior art in-ovo injection machine.

FIG. 2 is a side perspective view of the in-ovo injection machine of FIG. 1.

FIG. 3 is a front end view of an in-ovo injection machine modified to include a vibration mechanism in accordance with the present invention.

FIG. 4 is a top side perspective view of the vibration mechanism of FIG. 3 as mounted on the linear actuator cover of an in-ovo injection machine.

FIG. 5 is a bottom side perspective view of the vibration mechanism of FIG. 4.

FIG. 6 is a front end view of the vibration mechanism of FIGS. 4 and 5, supporting an egg tray loaded with eggs.

FIG. 7 is a top side perspective view of the vibration mechanism of FIG. 6.

FIG. 8 is a conceptual illustration of the components of a vibration unit in accordance with the present invention.

### DETAILED DESCRIPTION OF THE PREFERRED EMBODIMENTS

Although only one preferred embodiment of the invention is explained in detail, it is to be understood that the embodiment is given by way of illustration only. It is not intended that the invention be limited in its scope to the details of construction and arrangement of components set forth in the following description or illustrated in the drawings. Also, in describing the preferred embodiments, specific terminology will be resorted to for the sake of clarity. It is to be understood that each specific term includes all technical equivalents which operate in a similar manner to accomplish a similar purpose.

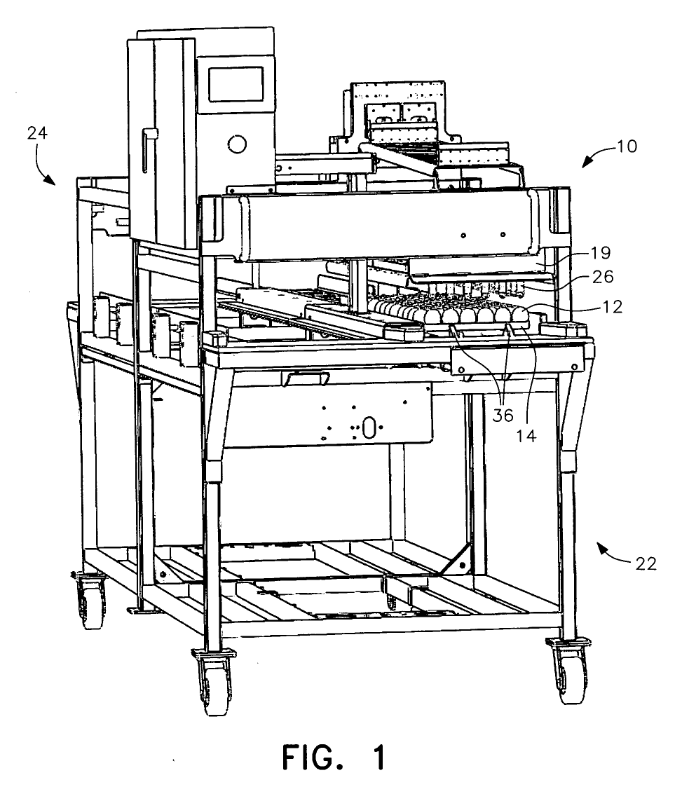

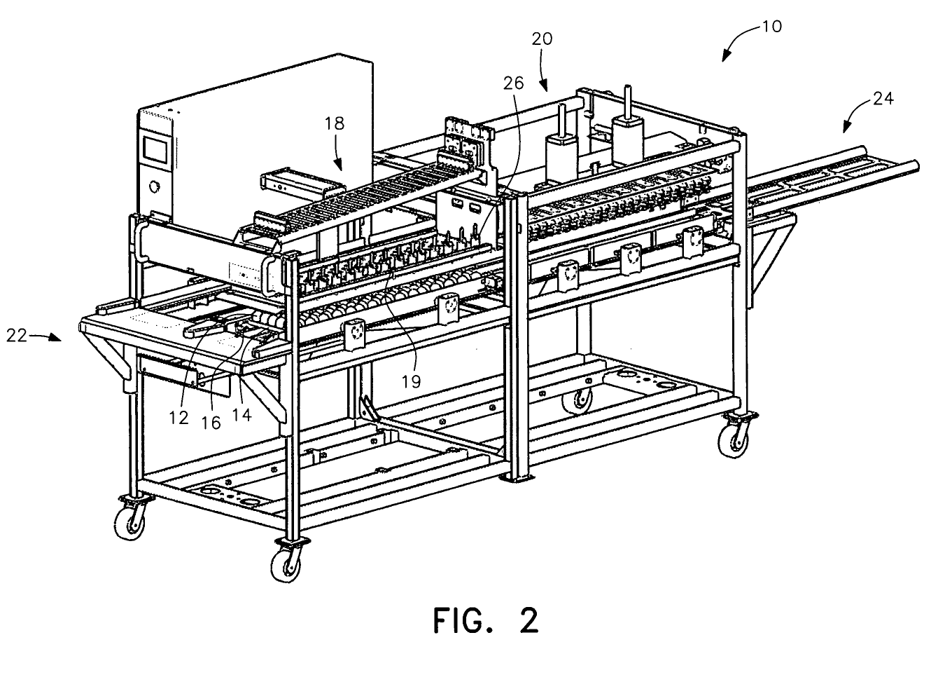

Shown in FIGS. 1 and 2 is an INTELLIJECT® in-ovo injection machine loaded with eggs for injection and generally designated by the reference numeral 10. The INTELLIJECT® in-ovo injection machine 10 is manufactured by the present assignee, and its basic structure and operation are described in detail in U.S. Pat. No. 7,096,820 (“the '820 patent”); the '820 patent is hereby expressly incorporated by reference in its entirety as if fully set forth herein.

In use of the INTELLIJECT® in-ovo injection machine 10, eggs 12 supported in egg trays 14 are moved longitudinally along tracks 16 from an injection section, generally designated by the reference numeral 18, at the front of the machine to an egg transfer section, generally designated by the reference numeral 20, at the back thereof. The front and back of the machine 10 are generally designated by the reference numerals 22 and 24, respectively.

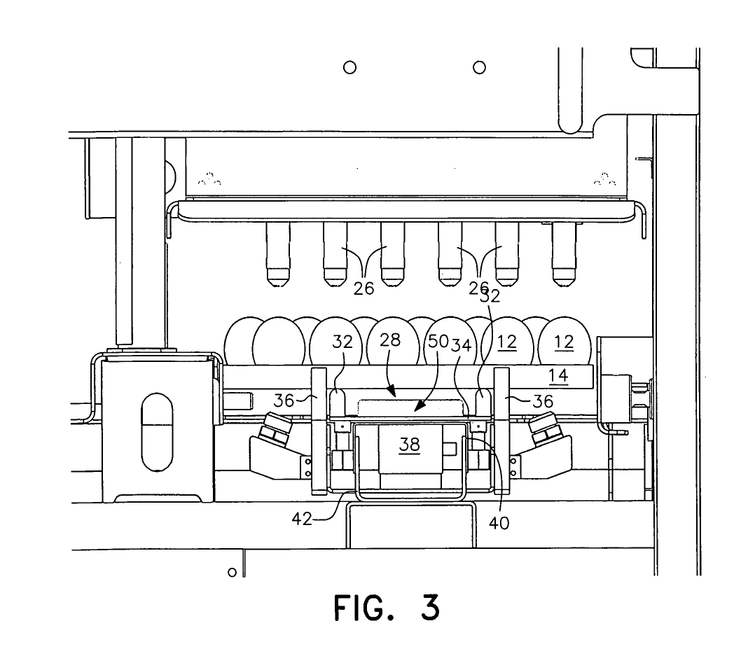

In the injection section 18, an injector assembly 19 supports a plurality of injectors 26 arranged in a pattern corresponding to that of the eggs in the egg tray 14. When the injector assembly 19 is lowered, the injectors each come into contact with their respective eggs 12. The eggs are then injected with a vaccine or other desired substance, after which the injector assembly 19 raises the injectors 26 and the egg tray 14 is moved rearwardly along the tracks 16 to the egg transfer section 20 by pusher fingers 36 that move in response to force generated by a linear actuator 38 (see FIG. 3). The linear actuator 38 is nested under an actuator cover 40 and supported at each end by a holding bracket 42 (see FIG. 3). A complete description of the steps by which the egg tray is moved longitudinally through the in-ovo egg injection machine is set forth in the '820 patent. The egg injection and egg transfer sections are also fully described in the '820 patent and therefore will not be discussed further herein as pertaining to their basic operation.

FIG. 3 illustrates a front end view of the in-ovo injection machine of FIGS. 1 and 2, as modified to include a vibration mechanism, generally designated by the reference numeral 28, in accordance with the present invention. In the modified machine, generally designated by the reference numeral 30, the egg tray 14 is supported on the vibration mechanism 28.

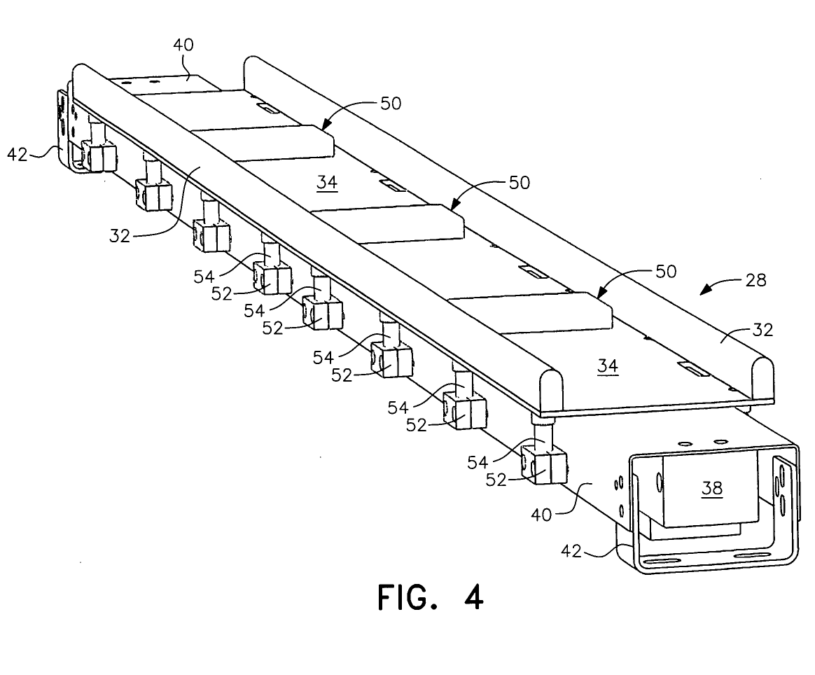

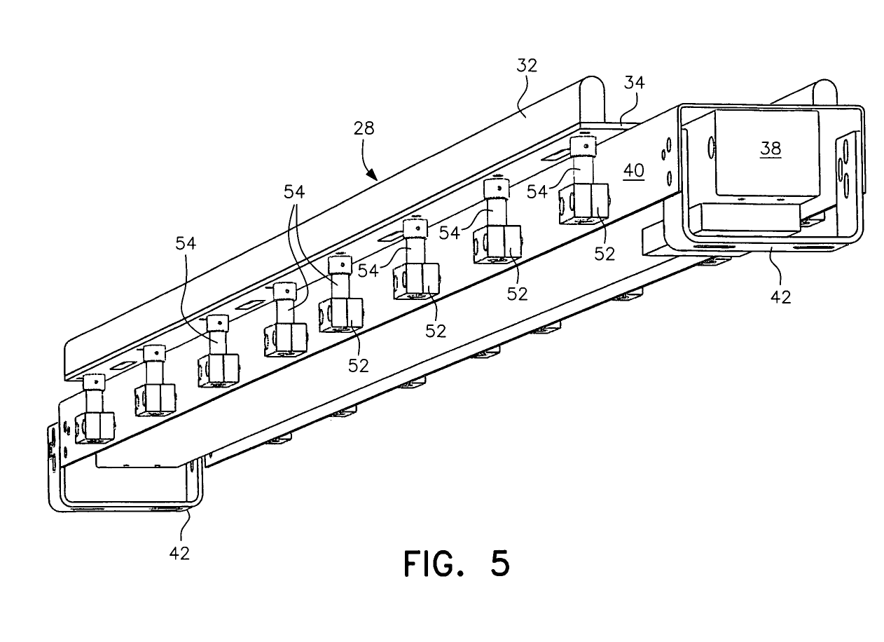

As shown in the top side perspective view of FIG. 4, the vibration mechanism 28 includes two spaced rails 32 that are joined by a track plate 34. The track plate 34 of the vibration mechanism 28 is provided with a plurality of vibration units, generally designated by the reference numeral 50, that extend between the rails 32 and are longitudinally spaced from one other along the track plate 34. Each vibration unit 50 generates a vibratory force which is transferred to the track plate 34 and the rails 32. The vibration mechanism further includes a plurality of dampener clamps 52 and a plurality of vibration dampeners 54. The track plate 34 is coupled to the actuator cover 40 by the plurality of dampener clamps 52 which are held in a spaced relationship with respect to the track plate by the plurality of vibration dampeners 54. The vibration dampeners 54, which are preferably made of an elastomeric material, allow for vibratory movement of the track plate 34 and rails 32 relative to the actuator cover 40. Another side perspective view of the structure of FIG. 4, this time looking upwardly from underneath the linear actuator 38 and track plate 34, is shown in FIG. 5.

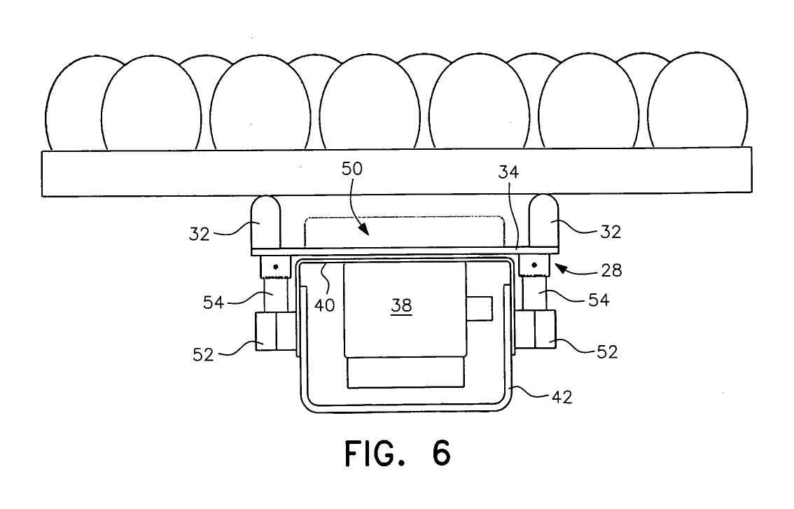

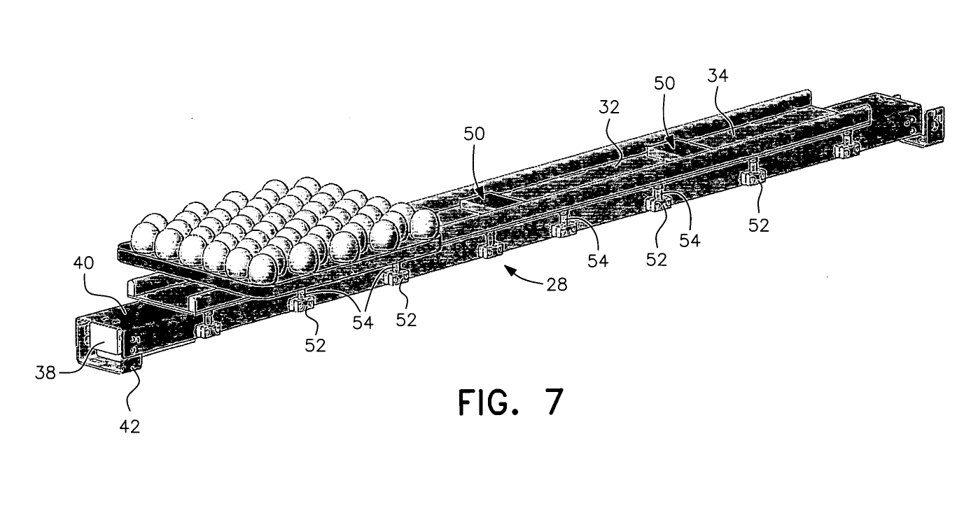

A front view of the actuator 38, actuator cover 40, supporting bracket 42, and vibration mechanism 28 including dampener clamps 52, vibration dampeners 54, track plate 34, rails 32 and vibration unit 50, as loaded with eggs 12 on an egg flat 14, is shown in FIG. 6. A side perspective view of the same components is provided in FIG. 7.

The vibration generated by the vibration units 50 is preferably in the range of about 30 pounds force to about 100 pounds force and is applied to the track plate and side rails for about 1-4 seconds. According to one preferred embodiment, the vibratory force is applied for about 2.5 seconds. During this time, friction between the eggs 12 and the posts (not shown) of the tray 14 is reduced by the vibrating movement such that the eggs are made to “float” within their restricted positions in the tray. Due to the natural bottom-heaviness of the eggs caused by positioning of the yolk fluid in the lower portion of the egg, and due to the egg shape (larger at the top than the bottom), the eggs in this lightened or “floating” state are able to self-align their axes into a vertical orientation in response to the force of gravity.

The elastomeric material of the vibration dampeners 54 is preferably polyurethane with a durometer of about 30-60 and a deflection of about 0.020″ to about 0.125″. This degree of elasticity allows a sufficient magnitude of track plate vibration while ensuring that excessive vibration does not occur. Vibration intensity is also preferably adjustable to correspond with the egg tray and its total mass and weight.

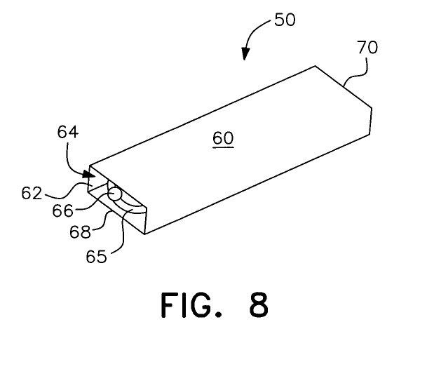

According to one preferred embodiment illustrated in FIG. 8, the vibration unit includes an outer housing 60 having a plurality of walls 62 that define an enclosed inner area, generally designated by the reference numeral 64. The inner area has a circular track 65 that restricts movement to one plane. A ball 66 is placed in the inner area 64 and is free to move about the track 65 in a circular fashion. The housing 60 is further provided with an inlet 68 and an outlet 70 which are preferably located on opposite ends of the housing. Forced air is injected into the inlet 68 and allowed to escape through the outlet 70. The air passing through the inner area 64 within the housing 60 contacts the ball 66 and causes it to roll about the track where, once in motion, it continues to move in a circular fashion through the forces of inertia, momentum and centrifugal force.

The ball 66 is preferably made of metal such as steel, but can be made of other materials of sufficient hardness and weight to result in vibration by the movement thereof as described. The vibrator housing 60 preferably has a hardened material insert so that the desired vibration through contact of the ball therewith is achieved.

The present invention is not limited, however, to this specific mechanical design for generating vibration. On the contrary, the vibration may be generated using a wide variety of mechanisms which may be mechanical, pneumatic, hydraulic, electronic, electrical or ultrasonic in design, or some combination thereof, or other vibration-creating mechanisms. In addition, the vibration units can be positioned to transmit vibration to the egg tray from any angle, whether from the top, bottom or side of the tray, to create the desired egg “floating” movement.

The present invention is also directed to a method of injecting eggs using an in-ovo injection machine and a vibration mechanism to bring the axes of the eggs into vertical self-alignment with the established vertical axes of the injectors. The direction of the force generated by the vibrator can be parallel or perpendicular to the plane of the egg tray (or at any angle in between). According to the method, vibration force is applied to an egg tray prior to injection using a vibration mechanism. The vibration mechanism can be used in line independently of the in-ovo injection machine or a candling machine or can be incorporated within the in-ovo injection machine or candling machine to apply the vibratory force to the egg tray just prior to in-ovo injection. Vibration on the order of about 30-100 pounds force, and preferably on the order of about 30-60 pounds force, is applied to the egg tray for about 1-4 seconds, allowing the eggs to vertically self-align with respect to the established vertical axes of the injectors. The eggs are then injected with less likelihood of muscular or body injections and the trauma resulting therefrom.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. An egg injection machine comprising a plurality of vertically moving injectors for simultaneously injecting vaccine into a plurality of eggs positioned in an incubating egg tray below said injectors and a vibration mechanism to impart vibratory motion to said egg tray and said eggs therein to cause said eggs to align in said tray in a generally vertical orientation prior to said injectors injecting said vaccine into said eggs.

2. The egg injection machine as set forth in claim 1, wherein said vibration mechanism includes a support structure upon which said incubating egg tray is placed and a vibration unit associated with said support structure that generates said vibratory motion.

3. The egg injection machine as set forth in claim 2, wherein said support structure includes two spaced support rails arranged in a substantially parallel relationship and joined by a track plate, said vibration unit being positioned on said track plate between said rails, said egg tray when resting on said support rails being in a spaced relationship above said vibration unit.

4. The egg injection machine as set forth in claim 3, wherein said vibration mechanism further includes a plurality of dampening devices in abutment with an underside of said track plate that allow for said vibratory movement of said track plate and support rails relative to an underlying portion of said egg injection machine.

5. The egg injection machine as set forth in claim 4, wherein said dampening devices include clamps configured to mount said vibration mechanism to an actuator cover of said egg injection machine and dampeners made of elastomeric material which hold the clamps in a spaced relationship relative to the track plate.

6. The egg injection machine as set forth in claim 2, wherein said vibration unit includes a housing defining an enclosure that contains a track and a movable part that, when moved on said track, generates said vibratory force.

7. A vibration mechanism in combination with an incubating egg tray, said vibration mechanism comprising a support structure upon which said incubating egg tray is placed and a vibration unit associated with said support structure that generates a vibratory force which is transferred to said support structure and to said incubating egg tray thereon, said vibratory force being effective to convey a vibratory movement to eggs contained in said incubating egg tray to cause said eggs to self-align in to a generally vertical orientation.

8. The combination as set forth in claim 7, wherein said vibration mechanism includes a plurality of vibration units spaced along said support structure.

9. The combination as set forth in claim 7, wherein said support structure includes two spaced support rails arranged in a substantially parallel relationship and joined by a track plate, said vibration unit being positioned on said track plate between said rails, said egg tray when resting on said support rails being in a spaced relationship above said vibration unit.

10. The combination as set forth in claim 9, wherein said vibration mechanism further includes a plurality of dampening devices in abutment with an underside of said track plate that allow for said vibratory movement of said track plate and support rails relative to an underlying support surface upon which said vibration mechanism is mounted.

11. The combination as set forth in claim 10, wherein said dampening devices include clamps configured to mount said vibration mechanism to the underlying support surface and dampeners made of elastomeric material which hold the clamps in a spaced relationship relative to the track plate.

12. The combination as set forth in claim 11, wherein the underlying support surface is an actuator cover of an egg injection machine, said combination being configured for use together with said egg injection machine.

13. The combination as set forth in claim 11, wherein said elastomeric material is polyurethane with a durometer of about 30-60 and a deflection of between about 0.020″ to about 0.125″.

14. The combination as set forth in claim 7, wherein said vibration unit includes a housing defining an enclosure that contains a track and a ball that, when moved on said track, generates said vibratory force.

15. A method of aligning eggs held in an incubating egg tray into a vertical orientation using a vibration mechanism having a support structure and a vibration unit comprising the steps of:
placing an incubating egg tray with eggs held therein onto said vibration mechanism support structure;
activating the vibration unit to generate a vibratory force which is transferred to said support structure and to said incubating egg tray thereon; and
applying said vibratory force to said incubating egg tray until the eggs contained in said incubating egg tray self-align into a generally vertical orientation.

16. The method as set forth in claim 15, wherein said vibratory force is applied to said incubating egg tray for about 1-4 seconds.

17. The method as set forth in claim 15, wherein said vibratory force is applied to said incubating egg tray for about 2.5 seconds.

18. The method as set forth in claim 15, wherein the vibratory force generated by said vibration unit is in a range of about 30 pounds force to about 100 pounds force.

19. The method as set forth in claim 15, wherein said vibration unit includes a housing defining an enclosure in communication with an inlet and an outlet, and has a movable part contained within said enclosure, said step of activating said vibration unit including injecting forced air through said inlet to initiate movement of said movable part within said enclosure which generates said vibratory force.
